(19) United States
(12) Patent Application Publication
(10) Pub. No.: US 2018/0216348 A1
(43) Pub. Date: Aug. 2, 2018

(54) GUTTER COVER SUPPORT BRACKET

(71) Applicant: Products Innovation Group, Inc., Rochelle, VA (US)

(72) Inventors: Anthony W. MORRIS, Tampa, FL (US); Evelyn M. ROBINS, Ruckersville, VA (US)

(73) Assignee: Products Innovation Group, Inc., Rochelle, VA (US)

(21) Appl. No.: 15/420,423

(22) Filed: Jan. 31, 2017

(51) Int. Cl. E04D 13/076; F16M 13/02; F16B 2/24; F16B 2/22

(52) U.S. Cl. CPC E04D 13/076; F16B 2/22; F16B 2/243; F16M 13/022

(57) ABSTRACT

A support bracket for supporting a gutter cover on a gutter having an outer lip. The support bracket comprises a first leg having an outer end positioned within the outer gutter lip and an inner end extending downwardly and inwardly from the outer end thereof and merging with a second leg that extends inwardly and upwardly to a high point. The second leg merges with a third leg at the high point that extends downwardly and inwardly into engagement with an inner portion and bottom of the gutter. The high point of the support bracket is positioned at a height above the outer gutter lip to ensure that a gutter cover positioned on the bracket will have a slope extending downwardly toward the outer gutter lip.

### BACKGROUND OF THE INVENTION

### 1. Field of the Invention

The present invention relates to a gutter cover support bracket and, more particularly, to such a bracket that supports a gutter cover at a downward and outward slope when it is installed on a gutter.

### 2. Description of the Background Art

It is important to mount a gutter cover on a gutter at a slope downwardly toward the outer edge of the gutter to augment shedding of debris and the like. In some instances, installers lay the gutter cover in a flat orientation on the gutter and thus cause problems by creating issues of clogging of debris on the gutter cover.

### BRIEF SUMMARY OF THE INVENTION

To ensure that gutter covers are installed with the proper slope, the present invention is a support bracket that can be easily installed in a gutter at predetermined intervals to support the gutter cover at a required downward and outward slope when it is installed on a gutter.

The support bracket comprises a first leg that is positioned at its outer end within the outer lip of the gutter. The inner end of the first leg extends downwardly and inwardly and merges with a second leg that extends inwardly and upwardly to a high point where it merges with a third leg that extends downwardly and inwardly into engagement with the inner portion and bottom of the gutter. The third leg terminates at its lower end in an outwardly extending support tab in engagement with the gutter bottom. The high point of the support bracket is positioned at a height above the outer gutter lip to ensure that a gutter cover positioned on the bracket will have a slope extending downwardly toward the outer gutter lip.

### BRIEF DESCRIPTION OF THE DRAWINGS

FIG. 1 is a perspective view of the support bracket of the present invention installed in a gutter; and

FIG. 2 is a perspective view similar to FIG. 1, with parts broken away, showing a gutter cover installed on a support bracket and a gutter.

### DETAILED DESCRIPTION OF THE INVENTION

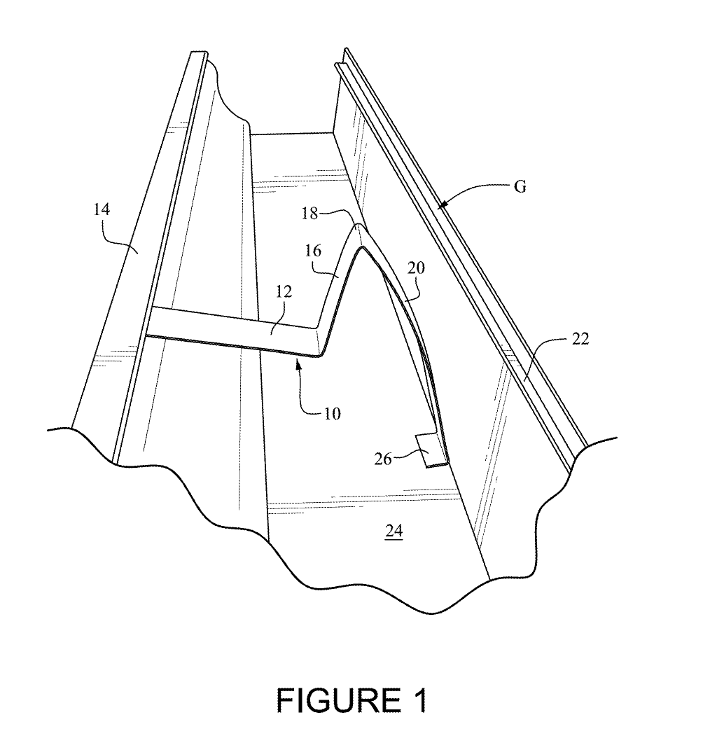

As shown in FIG. 1, the support bracket 10 comprises a first leg 12 that is positioned at its outer end within the outer lip 14 of the gutter G. The inner end of the first leg 12 extends downwardly and inwardly and merges with a second leg 16 that extends inwardly and upwardly to a high point 18 where it merges with a third leg 20 that extends downwardly and inwardly into engagement with the inner portion 22 and bottom 24 of the gutter G. The third leg 20 terminates at its lower end in an outwardly extending support tab 26 in engagement with the gutter bottom 24.

The high point 18 of the support bracket 10 is positioned at a height above the outer gutter lip 14 to ensure that a gutter cover positioned on the bracket 10 will have a slope extending downwardly toward the outer gutter lip 14.

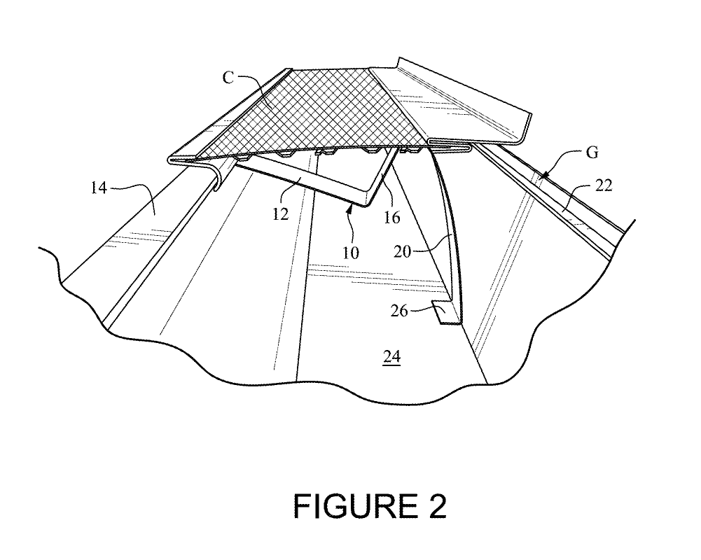

FIG. 2 illustrates a portion of a gutter cover C mounted on the bracket 10 and the gutter G so that it is supported by the high point 18 at the merger of the second leg 16 and third leg 20 and has a slope extending downwardly toward the front lip 14 of the gutter.

The support bracket 10 may be formed of any suitable flexible and resilient material, such as plastic or metal that will not deteriorate when exposed to moisture.

Also, any suitable number of support brackets 10 may be mounted at predetermined intervals in a gutter G to properly support the gutter cover C thereon.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. (canceled)

2. The support bracket and gutter of claim 6 wherein the third leg terminates at a lower end thereof in an outwardly extending support tab in engagement with the gutter bottom.

3. The support bracket and gutter of claim 6 wherein the support bracket is formed of a flexible and resilient material.

4. The support bracket and gutter of claim 3 wherein the support bracket is formed of metal or plastic.

5. The support bracket and gutter of claim 6 wherein a plurality of support brackets are mounted at predetermined intervals in the gutter to support a gutter cover thereon that slopes downwardly toward the outer gutter lip.

6. A support bracket and gutter construction for supporting a gutter cover, comprising a gutter having an open upper portion and an outer lip adjacent to the open upper portion, the support bracket comprising a first leg having an outer end positioned within the outer gutter lip, the first leg extending from the outer end thereof downwardly and inwardly into a midportion of the gutter where the first leg merges with a second leg that extends inwardly and upwardly toward the open upper portion of the gutter to a high point disposed in the open upper portion of the gutter where the second leg merges with a third leg that extends downwardly and inwardly into engagement with a bottom of the gutter, the high point of the support bracket being positioned at a height above the outer gutter lip to ensure that a gutter cover positioned on the support bracket in the upper open portion of the gutter will have a slope extending downwardly toward the outer gutter lip.
